(19) United States
(12) Patent Application Publication
(10) Pub. No.: US 2012/0124674 A1
(43) Pub. Date: May 17, 2012

(54) RIGHT MANAGEMENT APPARATUS, RIGHT MANAGEMENT PROGRAM, AND CONTENT PLAYBACK SYSTEM

(75) Inventor: Yasuyuki Umehara, Niiza-shi, Saitama (JP)

(73) Assignee: PIONEER CORPORATION, Kawasaki-shi, Kanagawa (JP)

(21) Appl. No.: 13/375,278

(22) PCT Filed: Jun. 3, 2009
(86) PCT No.: PCT/JP2009/060152

§ 371 Date: Dec. 22, 2011

(51) Int. Cl. G06F 21/24

(52) U.S. Cl. 726/27

(57) ABSTRACT

In a content playback system 2, when receiving, from an information playback apparatus, a first request that queries a right status and a playback status of a digital content, a right management apparatus 7 references a right management DB to obtain the right status, and obtains the playback status from an information playback apparatus having the playback right of the digital content. The right management apparatus 7 transmits, to the information playback apparatus 5, a first response indicative of the right status and playback status of the digital content. When determining, based on the received first response, the information playback apparatus 5 that the digital content is not being played back, transfers, based on the right status of the received first response, the playback right of the digital content from the information playback apparatus having the playback right of the digital content to the corresponding apparatus.

### TECHNICAL FIELD OF THE INVENTION

The present invention relates to technologies for managing the rights of digital contents protected by DRM (Digital Rights Management), and, more particularly, can be applied for Managed copy.

### BACKGROUND ART

One standard of “Managed copy” is established in the Advanced Access Control System, which is a digital content protection technology employed by next-generation optical discs, such as Blu-ray discs. The “Managed copy” is a function of authorizing copies of digital contents by performing authentication via networks. For example, when a purchased optical disc is inserted into an information recording/playback apparatus meeting Managed copy, such as a blu-ray disc recorder, for copying, the information recording/playback apparatus transmits a query to a managed-copy server that manages the number of copies, and obtains information associated with the number of copies of the optical disc. Then, the information recording/playback apparatus determines whether to authorize a copy process, thus carrying out the copy process.

In the standard of Managed copy, playback of copied digital contents (digital contents in their destinations is authorized by only an information recording/playback apparatus that has copied the digital contents, so the copied digital contents cannot be played back by another information recording/playback apparatus.

Of course, concepts associated with transfer of rights to play back are incorporated into the Managed copy in consideration of failure of an information recording/playback apparatus that has copied and/or convenience of users in replacement of their information recording/playback apparatuses.

Note that the inventors have filed the following first and second patent applications related to the “Managed copy”. In addition, the following third patent application related to transfer of rights to play back has been filed.

### CITATION LIST

### Patent Document

First patent document: International Publication NO. WO/2008/126318
Second patent document: International Publication NO. WO/2008/126285
Third patent document Japanese Patent Laid-Open No. 2000-347946

### DISCLOSURE OF THE INVENTION

### Problems to be Solved by the Invention

In the Managed copy, transfer procedures of playback rights between two information recording/playback apparatuses requires mutual authentication between the two apparatuses first, and thereafter transfer of right information (certificate data on playback rights) therebetween. In addition, such procedures must be performed with a carriable recording medium, such as a memory card, being alternately installed in the apparatuses. That is, transfer of playback rights requires these complicated and cumbersome procedures.

Recently, there are DLNA (Digital Living Network Alliance) certified information recording/playback apparatuses, and therefore, digital contents are often played back under environments in which they are connected with a home network (a home LAN). Under such environments, a plurality of information recording/playback apparatuses connected with a home network can play back digital contents stored in a server.

However, in the Managed copy, digital contents stored in a server cannot be played back by any information recording/playback apparatuses except for information recording/playback apparatuses to which their playback rights are given unless transfer of playback rights. This cannot receive merits of network connection, resulting in reduction of convenience.

The present invention has been made in view of the aforementioned circumstances, and has an example of a purpose of providing a content playback system in which the playback right of a digital content is given to one information playback apparatus, and the playback right can be transferred; this content playback system is capable of simplifying playback of a digital content from an information playback apparatus with no playback right of the digital content.

### Means for Solving the Problems

In order to achieve such a purpose provided above, a first aspect of the present invention is a right management apparatus of a content playback system comprised of, on a predetermined network, an information storage apparatus storing therein one or more digital contents; the right management apparatus that manages playback rights of the digital contents stored in the information storage apparatus; and a plurality of information playback apparatuses for playing back the digital contents stored in the information storage apparatus, the information storage apparatus, the right management apparatus, and the plurality of information playback apparatuses being connected with each other, the playback rights of the digital contents being given to any one of the plurality of information playback apparatuses and being transferrable among the plurality of information playback apparatuses. The right management apparatus includes: an information storage means that stores therein right management information that correlates the digital contents stored in the information storage apparatus with the corresponding information playback apparatuses to which the playback rights of the digital contents are given; a first request receiving means that receives, from the information playback apparatus, a first request that queries a right status and a playback status of a selected digital content in the digital contents stored in the information storage apparatus; a right status obtaining means that references, based on the received first request, the right management information stored in the information storage means to obtain, as the right status, right management information representing that the playback right is given to which of the information playback apparatuses; a second request transmitting means that transmits, to the information playback apparatus having the playback right of the selected digital content according to the right status obtained by the right status obtaining means, a second request that queries a playback status representing that the selected digital content is playing back; a second response receiving means that receives, from the information playback apparatus having the playback right of the selected digital content, a second response indicative of the playback status of the selected digital content; and a first response transmitting means that transmits, to the information playback apparatus that has transmitted the first request, a first response created based on the right status obtained by the right status obtaining means and the playback status received by the second response receiving means, the first response representing the right status and playback status of the selected digital content.

A second aspect of the present invention is a right management program readable by a right management apparatus of a content playback system comprised of, on a predetermined network, an information storage apparatus storing therein one or more digital contents; the right management apparatus that manages playback rights of the digital contents stored in the information storage apparatus; and a plurality of information playback apparatuses for playing back the digital contents stored in the information storage apparatus, the information storage apparatus, the right management apparatus, and the plurality of information playback apparatuses being connected with each other, the playback rights of the digital contents being given to any one of the plurality of information playback apparatuses and being transferrable among the plurality of information playback apparatuses. The computer program functions the right management apparatus as: an information storage means that stores therein right management information that correlates the digital contents stored in the information storage apparatus with the corresponding information playback apparatuses to which the playback rights of the digital contents are given; a first request receiving means that receives, from the information playback apparatus, a first request that queries a right status and a playback status of a selected digital content in the digital contents stored in the information storage apparatus; a right status obtaining means that references, based on the received first request, the right management information stored in the information storage means to obtain, as the right status, right management information representing that the playback right is given to which of the information playback apparatuses; a second request transmitting means that transmits, to the information playback apparatus having the playback right of the selected digital content according to the right status obtained by the right status obtaining means, a second request that queries a playback status representing that the selected digital content is playing back; a second response receiving means that receives, from the information playback apparatus having the playback right of the selected digital content, a second response indicative of the playback status of the selected digital content; and a first response transmitting means that transmits, to the information playback apparatus that has transmitted the first request, a first response created based on the right status obtained by the right status obtaining means and the playback status received by the second response receiving means, the first response representing the right status and playback status of the selected digital content.

A third aspect of the present invention is a content playback system comprised of, on a predetermined network, an information storage apparatus storing therein one or more digital contents; a right management apparatus that manages playback rights of the digital contents stored in the information storage apparatus; and a plurality of information playback apparatuses for playing back the digital contents stored in the information storage apparatus, the information storage apparatus, the right management apparatus, and the plurality of information playback apparatuses being connected with each other, the playback rights of the digital contents being given to any one of the plurality of information playback apparatuses and being transferrable among the plurality of information playback apparatuses. The right management apparatus includes: an information storage means that stores therein right management information that correlates the digital contents stored in the information storage apparatus with the corresponding information playback apparatuses to which the playback rights of the digital contents are given; a first request receiving means that receives, from the information playback apparatus, a first request that queries a right status and a playback status of a selected digital content in the digital contents stored in the information storage apparatus; a right status obtaining means that references, based on the received first request, the right management information stored in the information storage means to obtain, as the right status, right management information representing that the playback right is given to which of the information playback apparatuses; a second request transmitting means that transmits, to the information playback apparatus having the playback right of the selected digital content according to the right status obtained by the right status obtaining means, a second request that queries a playback status representing that the selected digital content is playing back; a second response receiving means that receives, from the information playback apparatus having the playback right of the selected digital content, a second response indicative of the playback status of the selected digital content; and a first response transmitting means that transmits, to the information playback apparatus that has transmitted the first request, a first response created based on the right status obtained by the right status obtaining means and the playback status received by the second response receiving means, the first response representing the right status and playback status of the selected digital content. The information playback apparatus includes: a first request transmitting means that transmits, to the right management apparatus, the first request; a first response receiving means that receives the first response from the right management apparatus; a right transfer means that performs a right transfer task when it is determined, based on the playback status of the received first response, that the selected digital content is not playing back, the right transfer task transferring the playback right of the selected digital content from the information playback apparatus that has the playback right of the selected digital content to the corresponding apparatus, based on the right status of the received first response; and a content playback means that stores therein the playback right of the selected digital content, thus playing back the selected digital content.

### BRIEF DESCRIPTION OF THE DRAWINGS

FIG. 1 is a schematic structural view of a copy management system and a content playback system according to an embodiment of the present invention;

FIG. 2 is a structural view of copy management information managed by a managed-copy authorization serer of the copy management system according to the embodiment of the present invention;

FIG. 3 is a functional block diagram of a managed-copy compliant information recording apparatus of the copy management system according to the embodiment of the present invention;

FIG. 4 is a functional block diagram of a right management apparatus according to the embodiment of the present invention;

FIG. 5 is a structural view of right management information managed by the right management apparatus according to the embodiment of the present invention;

FIG. 6 is a flowchart illustrating right transfer operations of a managed-copy compliant information recording apparatus of the copy management system according to the embodiment of the present invention;

FIG. 7 is a flowchart fully illustrating the flow of a certification data transfer task in step S80 of FIG. 6;

FIG. 8 is a flowchart illustrating, together with FIG. 9, the flow of right transfer operations of the right management apparatus of the copy management system according to the embodiment of the present invention;

FIG. 9 is a flowchart illustrating, together with FIG. 8, the flow of the right transfer operations of the right management apparatus of the copy management system according to the embodiment of the present invention;

FIG. 10 is a view illustrating an example of content lists according to the embodiment of the present invention;

FIG. 11 is a flowchart illustrating right transfer operations of a managed-copy compliant information recording apparatus of the copy management system according to a modification of the embodiment of the present invention;

FIG. 12 is a flowchart fully illustrating content-list display operations in step S220 of FIG. 11; and

FIG. 13 is a view illustrating a modified example of content lists according to the embodiment of the present invention.

### EMBODIMENTS FOR CARRYING OUT THE INVENTION

Embodiments of the present invention will be described hereinafter with reference to the drawings.

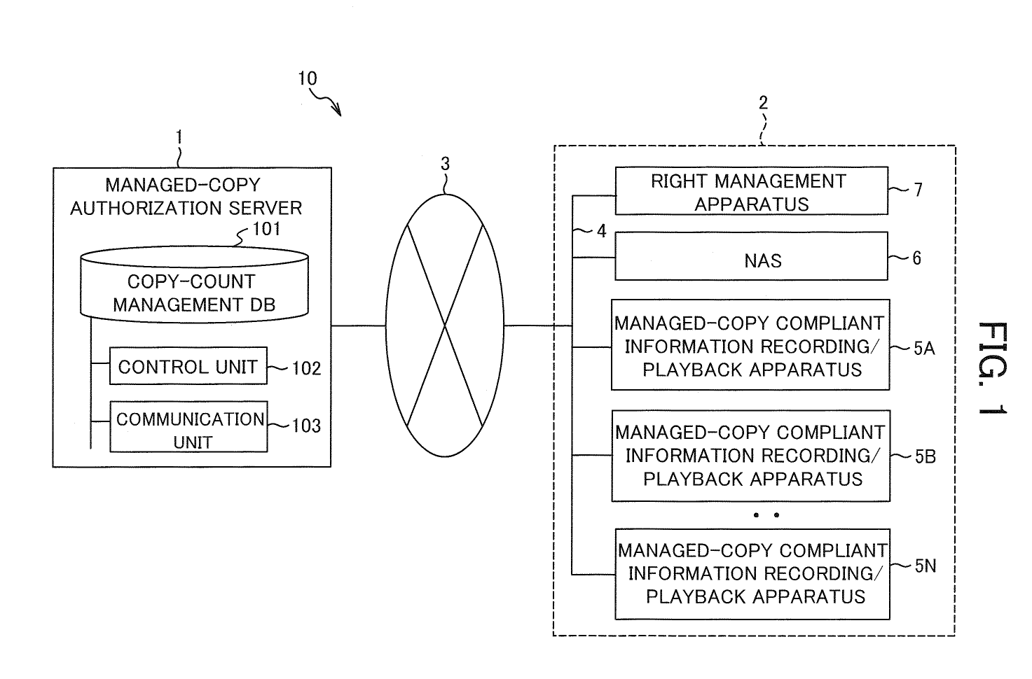

FIG. 1 is a schematic structural view of a copy management system 10 according to an embodiment of the present invention. The copy management system 10 illustrated in FIG. 1 is a computer system that conforms to the standard of “Managed Copy”, and is comprised of a managed-copy authorization server 1, a content playback system 2, and a communication network, such as an internet network, 3. The content playback system 2 consists of a plurality of managed-copy compliant information recording/playback apparatuses 5A, 5B, . . . , 5N (hereinafter, they will be collectively referred to as information recording/playback apparatuses 5). The communication network 3 allows mutual communications between the managed-copy authorization server 1 and the content playback system 2. This configuration allows a managed-copy compliant information recording/playback apparatus 5, which intends to copy digital contents recorded in an information recording medium (optical disc), to access to the managed-copy authorization server 1 so that the managed-copy authorization server 1, which manages information indicative of the number of copies, gives, to the managed-copy compliant information recording/playback apparatus 5, authorization to carry out copy processes. This allows the managed-copy compliant information recording/playback apparatus 5 to carry out copy processes. Hereinafter, a managed-copy compliant information recording/playback apparatus 5 will be referred to simply as an information playback apparatus 5.

The content playback system 2 is a managed-copy compliant content playback system, and, for example, is constructed in a home network (a home LAN) of a user's house. The content playback system 2 is comprised of the plurality of information recording/playback apparatuses 5, a NAS (Network Attached Storage) 6, and a right management apparatus 7. The NAS 6 stores therein copied digital contents (digital contents in their destinations) by the copy processes. The right management apparatus 7 manages playback rights of the digital contents stored in the NAS 6.

Specifically, in this embodiment, a digital content (a digital content in its destination) copied by an information playback apparatus 5 is stored in the NAS 6. In the standard of “Managed copy”, the playback right of each of copied digital contents (digital contents in their destinations) is given to a corresponding information playback apparatus 5 that performs a corresponding copy process. For this reason, the right management apparatus 7 is adapted to grasp information playback apparatuses 5 that respectively have performed copy processes to generate copied digital contents stored in the NAS 6 to thereby manage the playback rights of the digital contents stored in the NAS 6.

Hereinafter, a Blu-ray Disc recorder will be described as an information playback apparatus 5, but information recording apparatuses are not limited thereto. Any information recording apparatuses, which conform to the standard of “Managed Copy”, can be used. For example, HD DVD (High Definition DVD) recorders, DVD recorders, HDD recorders, AV servers, and computers can be used. Next-generation DVD players, such as BD players and HD DVD players, and playback devices, such as DVD players, can be used as long as they meet the standard of “Managed Copy”, and can perform copy processes.

The managed-copy authorization server, which will be referred to as a “server”, 1 is a server for managing the number of copies of each information recording medium (optical disc). Specifically, the server 1 is comprised of a copy-count management database, which will be referred to as a “copy-count management DB”, 101, a control unit 102, and a communication unit 103.

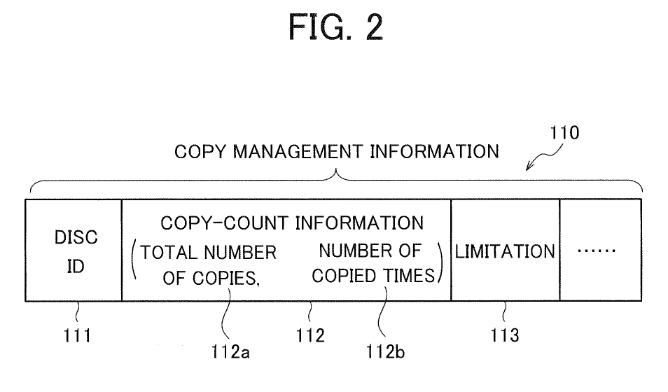

The copy-count management DB 101 is a database for managing the number of copies of each information recording medium (optical disc). Specifically, as illustrated in FIG. 2, the copy-count management DB 101 stores therein copy management information 110, and manages it; the copy management information 110 consists of items of disc IDs 111, copy-count information 112, and copy limitation information 113. In this embodiment, each disc ID 111 is comprised of a prerecorded media serial number and a corresponding content ID, which can uniquely identify a corresponding optical disc and a corresponding recorded content.

The copy-count information 112 includes the presently authorized number of copies representing the number of times that the corresponding disc can be copied at present. Specifically, the copy-count information 112 consists of the total number of copies 112a and the number of copied times 112b. The total number of copies 112 represents that the maximum number of copies predetermined for the corresponding optical disc, and the number of copied times 112b represents the number of times that have been already copied. For example, if the total number of copies is three and the number of copied times is one, the remaining two copies can be performed at present. The copy limitation information 113 includes a limitation if the limitation is put to a copy process. If a kind of information recording media as destinations of copy is limited, a limitation indicative of the kind of information recording media is the copy limitation information 113, and if copyright-protection systems in destinations of copy are limited, a limitation indicative of the copyright-protection systems is the copy limitation information 113. For example, information recording media each having the VGA size or lower are limited as destinations of copy are set as the copy limitation information 113.

The control unit 102 is comprised of a CPU including at least computing functions and control functions, and a main memory consisting of, for example, a ROM and a RAM, which has a function of storing programs and data. The control unit 102 is operative to carry out overall control of the server 1.

The communication unit 103 is operative to transmit and/or receive data to and/or from the managed-copy compliant information playback apparatus 5 via the communication network 3.

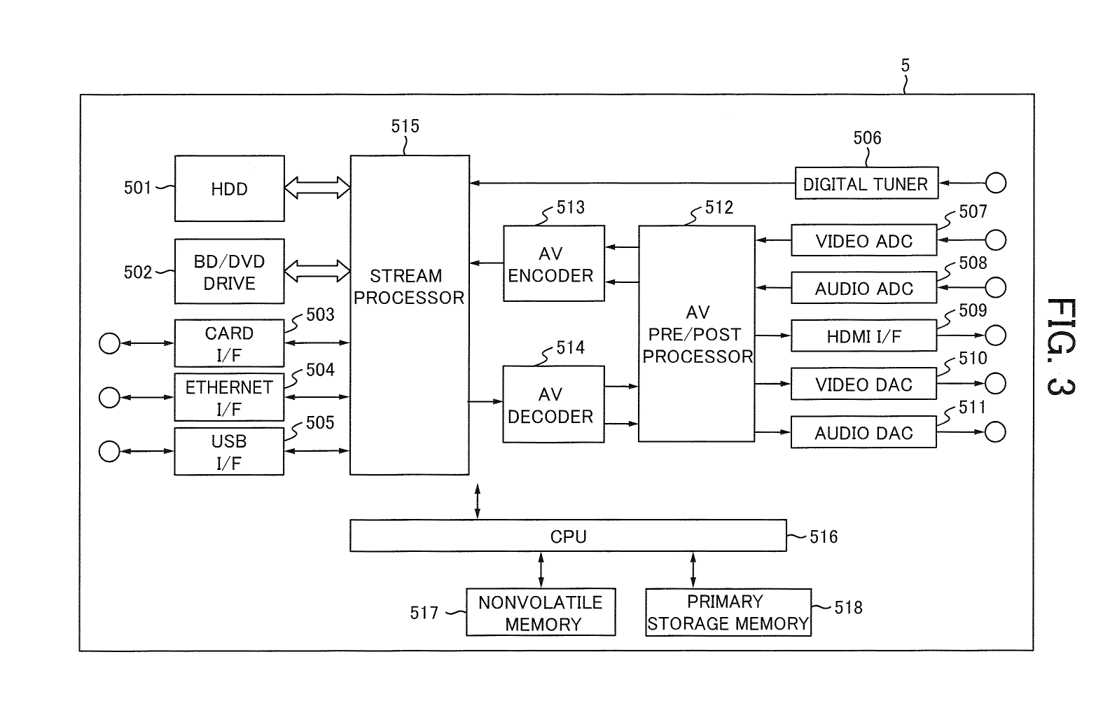

FIG. 3 is a functional block diagram of an information playback apparatus 5.

The information playback apparatus 5 is comprised of a high-speed storage 501 and a BD/DVD drive 502. The high-speed storage 501 is made up of, for example, a HDD (Hard Disc Drive) or an SSD (Solid State Drive), and operative to read data faster than at least an optical disc medium. The BD/DVD drive 502 is operative to record data into the high-speed storage, playback data therefrom, record data into a BD and/or DVD, and playback data therefrom.

The information playback apparatus 5 is also operative to communicate with externally-connected devices, such as memory cards, network devices, and USB devices, via interfaces including a card I/F 503, an Ethernet® I/F 504, and/or a USB interface 505. In this embodiment, it is possible to copy digital contents recorded in optical discs, such as Blu-ray discs and/or DVDs, to an optical disc, the high-speed storage, and/or an externally-connected device. However, in this embodiment, all copied digital contents are stored in the NAS 6.

A digital tuner 506 receives digital broadcasts. A video ADC (video A/D converter) 507 carries out analog-to-digital conversion of video signals inputted from external devices, and an audio ADC (audio A/D converter) 508 carries out analog-to-digital conversion of audio signals inputted from external devices.

A HDMI (High-Definition Multimedia Interface) I/F 509 carries out interface conversion of video signals, audio signals, and control signals according to the HDMI standard. A video DAC (video D/A converter) 510 carries out digital-to-analog conversion of video signals, and outputs converted analog video signals to external devices. An audio DAC (audio D/A converter) 511 carries out digital-to-analog conversion of audio signals, and outputs converted analog audio signals to external devices.

An AV pre/post processor 512 performs preprocessing of a video signal and an audio signal inputted from the respective video ADC 507 and the audio ADC 508 specifically including time-base correction, image-quantity improvement, and the like. The AV pre/post processor 512 also performs postprocessing of a video signal and an audio signal, specifically including image-quantity improvement, a compositing process, a pixel conversion process, a frame conversion process, or the like. The AV pre/post processor 512 outputs results of the postprocessing to the HDMI I/F 509, video DAC 510, and audio DAC 511.

An AV encoder 513 encodes and multiplexes a video signal and an audio signal outputted from the AV pre/post processor 212, and outputs the results to a stream processor 515. An AV decoder 514 performs a decode process and a data isolation process of a video signal and an audio signal inputted from the stream processor 515, and outputs the results to the AV pre/post processor 512. In the first embodiment, because copy is carried out between different information recording media, code conversion is carried out via the AV decoder 514 and the AV encoder 513.

The stream processor 515 performs control of data transfer, encryption of data, and/or decoding of encrypted data.

A CPU 516 serves as a computing and control means of the information playback apparatus 5, a nonvolatile memory 517 is means for storing programs and data, and a primary storage memory 518 serves as a primary storage means of stream data and/or display data.

Specifically, in the nonvolatile memory 517, programs, which cause the information playback apparatus 5 to perform various processes described later, are stored. These programs are stored in the nonvolatile memory 517, and can be stored in computer-readable recording mediums, such as a hard disc, a flexible disc, a CD-ROM, and a DVD, or can be distributed via a communication network.

The NAS 6 is a file server connected with the home network 4. The NAS 6 stores therein the copied digital contents from optical disks or the like set forth above. That is, the NAS 6 according to this embodiment serves as an information storage device that stores digital contents that the plurality of information playback devices 5 can play back, respectively.

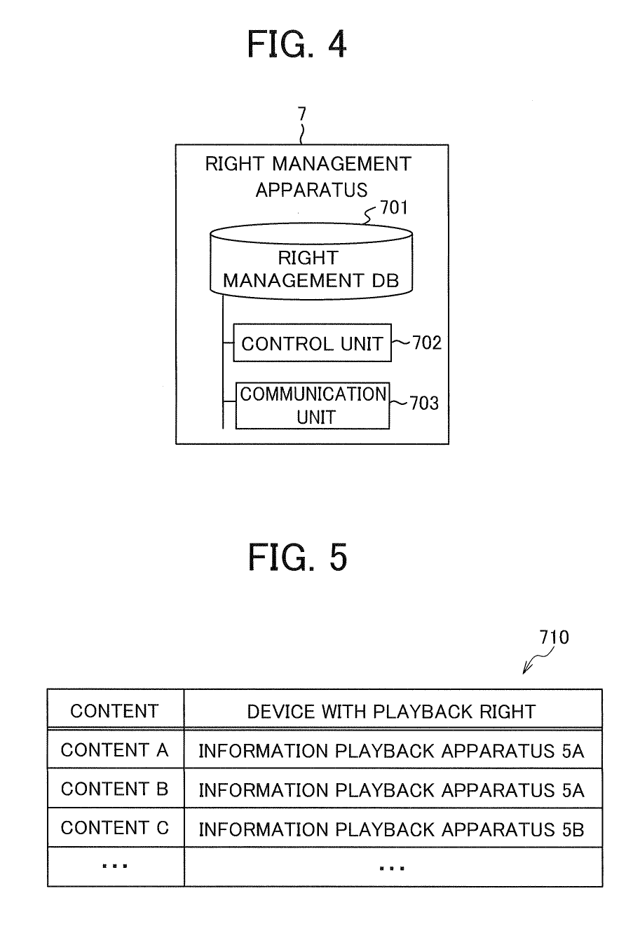

The right management apparatus 7 is an apparatus that manages the digital contents stored in the NAS 6. Specifically, as illustrated in FIG. 4, the right management apparatus 7 is comprised of a right management database (DB) 701, a control unit 702, and a communication unit 703. Specifically, the right management apparatus 7 is constructed by a computer (a personal computer).

The right management DB 701 is a database that manages at least one information playback apparatus 5 having the playback right of each of the digital contents copied in the content playback system 2. Specifically, as illustrated in FIG. 5, the right management DB 701 stores therein right management information 710 in which content identifying information, such as a content ID, for uniquely identifying a digital content stored in the NAS 6 and apparatus identifying information for uniquely identifying an information playback apparatus 5 having the playback right corresponding thereto are stored to be correlated with each other.

For example, when the information playback apparatus 5A copies a content A of a purchased optical disc to the NAS 6, because the information playback apparatus 5A has the playback right of the content A, the right management information 710 in which the content A and the information playback apparatus 5A are correlated with each other is included is stored in the right management DB 701.

Note that, in this embodiment, the fact that the information playback apparatus 5A has the playback right of the content A specifically means that the information playback apparatus 5A holds certification data (exactly, valid certification data) relating to the playback right of the content A automatically produced by the copy process of the information playback apparatus 5A. By holding the certification data relating to the playback right of the content A, the information playback apparatus 5A can play back the content A.

The control unit 702 is comprised of a CPU including at least computing functions and control functions, and a main memory consisting of, for example, a ROM and a RAM, which has a function of storing programs and data. The control unit 702 is operative to carry out overall control of the right management apparatus 7.

In the ROM of the control unit 702, programs, which cause the right management apparatus 7 to perform various processes described later, are stored. These programs are stored in the ROM, and can be stored in computer-readable recording mediums, such as a hard disc, a flexible disc, a CD-ROM, and a DVD, or can be distributed via a communication network.

The communication unit 703 is operative to transmit and/or receive data to and/or from each information playback apparatus 5 via the home network 4.

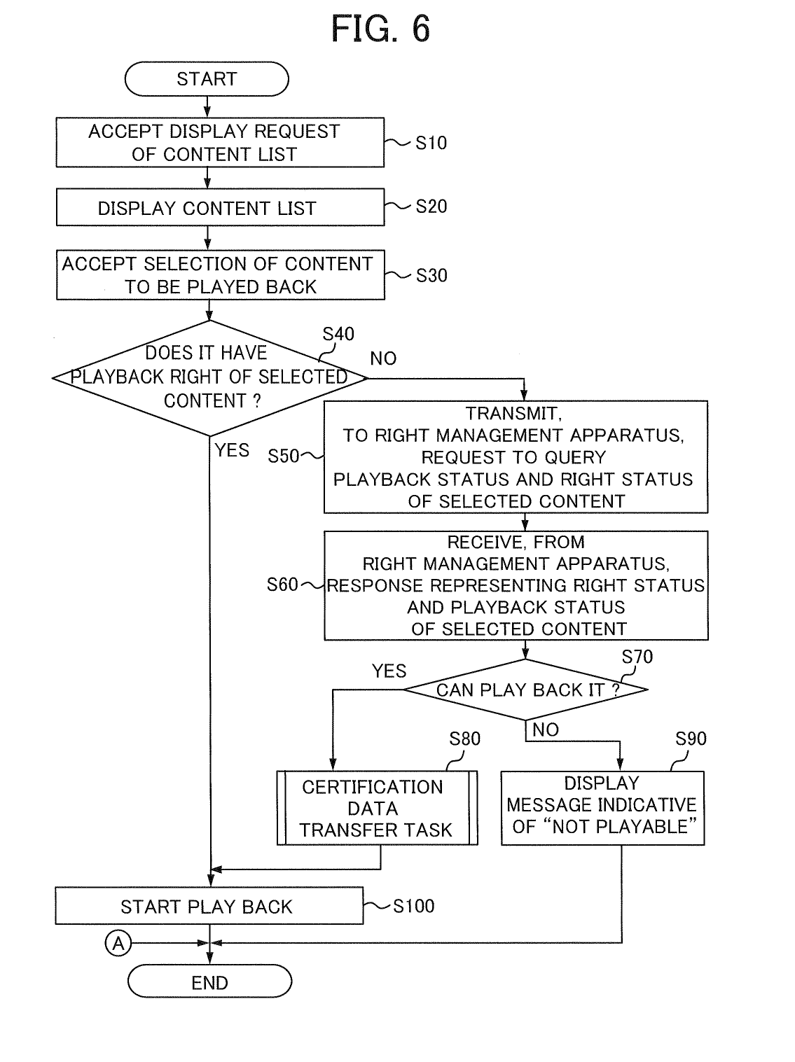

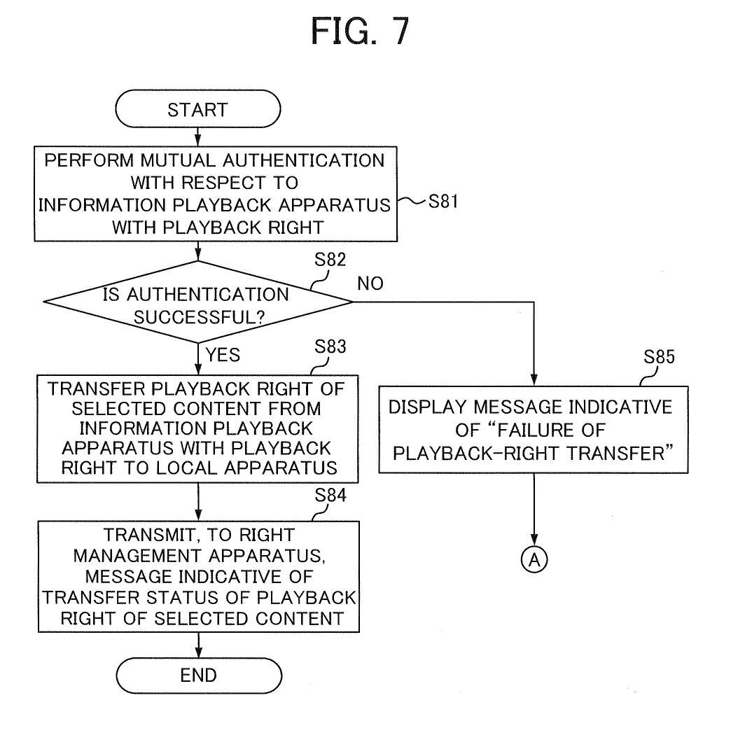

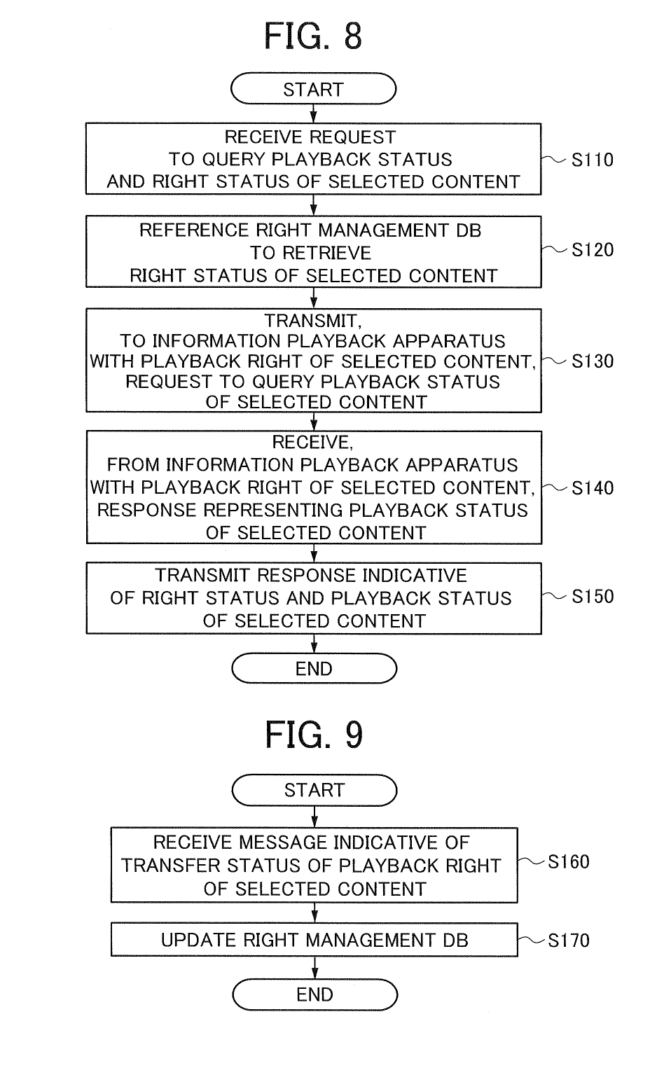

Next, right transfer operations of the content playback system 2 will be described with reference to FIGS. 6 to 9. Each of FIGS. 6 and 7 is a flowchart illustrating the flow of right transfer operations of an information playback apparatus 5 in the content playback system 2 when the information playback apparatus 5 plays back a digital content stored in the NAS 6. Note that the operations illustrated in FIGS. 6 and 7 are carried out by the CPU 516 of the corresponding information playback apparatus 5. Each of FIGS. 8 and 9 is a flowchart illustrating the flow of right transfer operations of the right management apparatus 7 when an information playback apparatus 5 in the content playback system 2 plays back a digital content stored in the NAS 6. Note that the operations illustrated in FIGS. 8 and 9 are carried out by the control unit 702 of the right management apparatus 7.

First, operations of an information playback apparatus 5 in the content playback system 2 when the information playback apparatus 5 plays back a digital content stored in the NAS 6 with reference to FIG. 6.

When accepting a display request of the list of contents from a user in step S10, an information playback apparatus 5 displays a content list L10 as the list of all digital contents stored in the NAS 6 on an image display device, such as a television, connected with the information playback apparatus 5 in step S20.

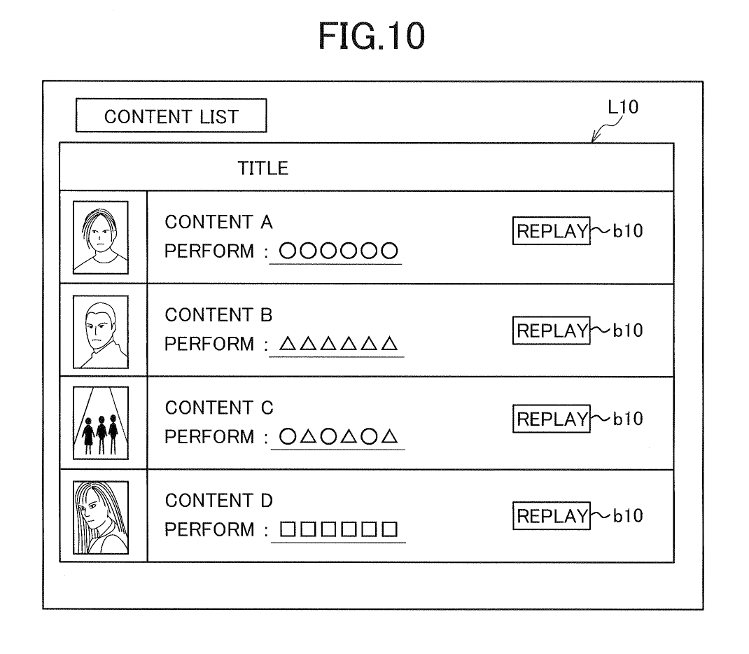

An example of the content list L10 is illustrated in FIG. 10. In the content list L10 illustrated in FIG. 10, for each digital content, the title and content attribute information (the title name, the jacket image of a corresponding content, and performer information) are displayed. This allows a user to select any of the digital contents in the content list L10. Specifically, selecting one of playback buttons b10 provided for the respective titles allows a corresponding digital content to be selected.

Next, when accepting selection of a digital content to be played back from a user in step S30, the information playback apparatus 5 determines whether it has the playback right of the selected digital content in step S40. Specifically, when holding therein the certification data relating to the playback right of the selected digital content, the information playback apparatus 5 determines that it has the playback right of the selected digital content. Otherwise, when the certification data relating to the playback right of the selected digital content is not held in the information playback apparatus 5, the information playback apparatus 5 determines that it does not have the playback right of the selected digital content.

When having the playback right of the selected digital content YES in step S40), the information playback apparatus 5 starts to play back the selected digital content in step S100.

Otherwise if the information playback apparatus 5 does not have the playback right of the selected digital content (NO in step S40), the information recording apparatus 5 transmits, to the right management apparatus 7, a request (a first request) that queries the playback status and the right status of the selected digital content in step S50. When receiving the first request, the right management apparatus 7 creates a response (a first response) to the first request, that is, a response representing the playback status and the right status of the selected digital content, and transmits it to the information playback apparatus 5. Operations of the right management apparatus 7 will be described in detail later.

Next, when receiving, from the right management apparatus 7, the response representing the playback status and the right status of the selected digital content in step S60, the information playback apparatus 5 determines whether the selected digital content can be played back because it can grasp, based on the information of the received response, which of the information playback apparatuses 5 has the playback right of the selected digital content, and whether an alternative information playback apparatus 5 having the playback right of the selected digital content is playing back the selected digital content in step S70.

Specifically, if an alternative information playback apparatus 5 having the playback right of the selected digital content is not playing back the selected digital content, the information playback apparatus 5 determines that the selected digital content can be played back because transfer of the playback right allows the information playback apparatus 5 to play back the selected digital content.

Otherwise, if an alternative information playback apparatus 5 having the playback right of the selected digital content is playing back the selected digital content, the information playback apparatus 5 determines that the selected digital content cannot be played back because the selected digital content cannot be played back simultaneously by two information playback apparatuses 5.

When determining that the information playback apparatus 5 determines that the selected digital content can be played back (YES in step S70), the information playback apparatus 5 performs a certification-data transfer task for transferring the certification data relating to the selected digital content from the alternative information playback apparatus 5 having the playback right of the selected digital content to the information playback apparatus 5 in step S80. If the certification data transfer task is successful, the information playback apparatus 5 starts to play back the selected digital content in step S100.

The certification data transfer task will be described in detail with reference to FIG. 7. FIG. 7 is a flowchart fully illustrating the flow of the certification data transfer task in step S80 of FIG. 6.

First, the information playback apparatus 5 performs mutual authentication between the corresponding apparatus (local apparatus) and the alternative information playback apparatus 5 with the playback right in step S81. For example, when the information playback apparatus 5A and the information playback apparatus 5B perform mutual authentication between therebetween, the information playback apparatus 5A checks whether the information playback apparatus 5B is an authorized apparatus that is in conformity with the specifications of Managed copy, and the information playback apparatus 5B checks whether the information playback apparatus 5A is an authorized apparatus that is in conformity with the specifications of Managed copy.

When determining that mutual authentication is successful (YES in step S82), the information playback apparatus 5 transfers the playback right of the selected digital content from the alternative information playback apparatus 5 with the playback right of the selected digital content to the corresponding local apparatus 5 in step S83.

For example, when the playback right of the selected digital content is transferred from the information playback apparatus 5B to the information playback apparatus 5A, the certification data relating to the selected digital content is transferred to the information playback apparatus 5A, and the certification data relating to the selected digital content stored in the information playback apparatus 5B is disabled. In addition, the certification data relating to the selected digital content stored in the information playback apparatus 5A is enabled.

Next, the information playback apparatus 5 transmits, to the right management apparatus 71, a message (right-transfer message) indicative of the transfer status of the playback right of the selected digital content, in other words, a message indicative of transfer of the playback right of the selected digital content to the corresponding local apparatus in step S84. For example, when the playback right of the selected content is transferred from the information playback apparatus 5B to the information playback apparatus 5A, a message representing that the playback right of the selected digital content belongs to the information playback apparatus 5A is transmitted to the right management apparatus 7. This results in that the right management apparatus 7 can grasp that the playback right of the selected content has been transferred.

On the other hand, when determining that mutual authentication is unsuccessful (NO in step S82), the information playback apparatus 5 displays a message indicative of “FAILURE OF PLAYBACK-RIGHT TRANSFER” on the image display device, such as a TV, connected with the information playback apparatus 5 in step S85, terminating the certification data transfer task illustrated in FIG. 6.

Otherwise, when determining that the information playback apparatus 5 determines that the selected digital content cannot be played back (NO in step S70), the information playback apparatus 5 displays a message indicative of “NOT PLAYABLE” (for example, “SELECTED DIGITAL CONTENT CANNOT BE PLAYED BACK AT PRESENT BECAUSE IT IS BEING PLAYED BACK BY ANOTHER APPARATUS”) on the image display device, such as a TV, connected with the information playback apparatus 5 in step S90. That is, in this case, transfer of the playback right of the selected digital content is not performed.

Next, operations of the right management apparatus 7 when an information playback apparatus 5 in the content playback system 2 plays back a digital content stored in the NAS 6 will be described hereinafter with reference to FIGS. 8 and 9.

First, operations of the right management apparatus 7 when it receives the first request from an information playback apparatus 5 will be described hereinafter with reference to FIG. 8. FIG. 8 is a flowchart illustrating the flow of the operations of the right management apparatus 7 when it receives the first request.

When receiving the request to query the playback status and right status of a selected digital content in step S110, the right management apparatus 7 references the right management DB 701 to retrieve the right status of the selected digital content therefrom in step S120. For example, if the right management information 710 illustrated in FIG. 5 is stored in the right management DB 701 and the selected digital content is the content C, it is determined that a device having the playback right is the information playback apparatus 5B.

Next, the right management apparatus 7 transmits, to an information playback apparatus 5 with the playback right of the selected digital content, a request (a second request) to query the playback status of the selected digital content in step S130. For example, if it is determined that a device having the playback right of the selected digital content is the information playback apparatus 5C as a result of the right status of the selected digital content, the right management apparatus 7 transmits the second request to the information playback apparatus 5C. When receiving the second request, the information playback apparatus 5 determines whether it is playing back the selected digital content, and transmits, to the right management apparatus 7, a response (a second response) indicative of the playback status of the selected digital content.

Next, the right management apparatus 7 receives the response indicative of the playback status of the selected digital content in step S140 to thereby obtain the playback status of the selected digital content.

Next, because the right management apparatus 7 grasps the right status and the playback status of the selected digital content, the right management apparatus 7 creates a response indicative of the right status and the playback status of the selected digital content, and transmits, to the information playback apparatus 5 that has transmitted the first request, the created response in step S150.

Next, operations of the right management apparatus 7 when it receives the right-transfer message from an information playback apparatus 5 will be described hereinafter with reference to FIG. 9. FIG. 9 is a flowchart illustrating the flow of the operations of the right management apparatus 7 when it receives the right-transfer message.

When receiving the right-transfer message indicative of the transfer status of the selected digital content in step S160, the right management apparatus 7 updates the right management DB 701. For example, when the right-transfer message represents that the information playback apparatus A has the playback right of the content C, it is updated to right management information 701 representing that a device having the playback right of the content C is the information playback apparatus 5A.

As described above, according to this embodiment, the right management apparatus 7 collectively manages the playback rights of the respective digital contents stored in the NAS 6. For this reason, even if a playback request is transmitted from an information playback apparatus 5 that does not have the playback right of a digital content, the right management apparatus 7 causes automatic playback-right transfer between the information playback apparatus 5 that does not have the playback right of the digital content and another information playback apparatus 5 that has the playback right of the digital content. This makes it possible for a user to easily play back a desired digital content without concern for playback-right transfer processes and execution of a complicated procedure.

Specifically, in the content playback system 2 conforming to a standard, typified by the standard of “Managed Copy”, in which the playback right of each digital content is given to only one specified information playback apparatus and transfer of the playback rights can be carried out, it is possible for information playback apparatuses with no playback rights of digital contents to easily play back the digital contents.

Note that, in this embodiment, the content list L10 displays merely the title and content attribute information of each digital content, but the display mode of a content list is not limited thereto. For example, in addition to the title and content attribute information of each digital content, information indicative of the right status and/or playback status of a corresponding digital content can be displayed on a content list. In this modification, it is possible for a user to check whether a digital content to be played back can be played back before selecting it.

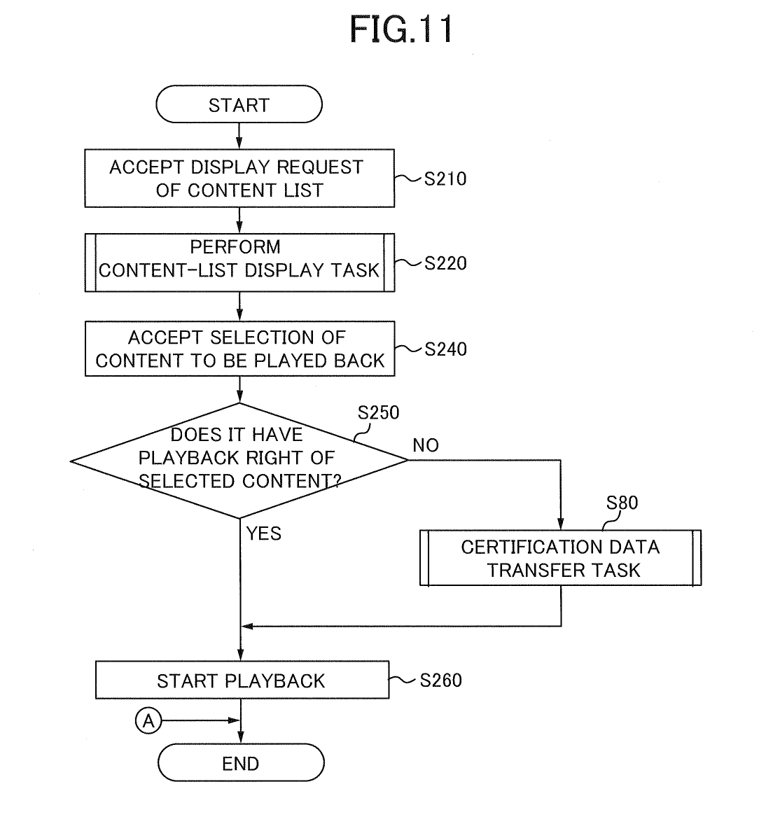

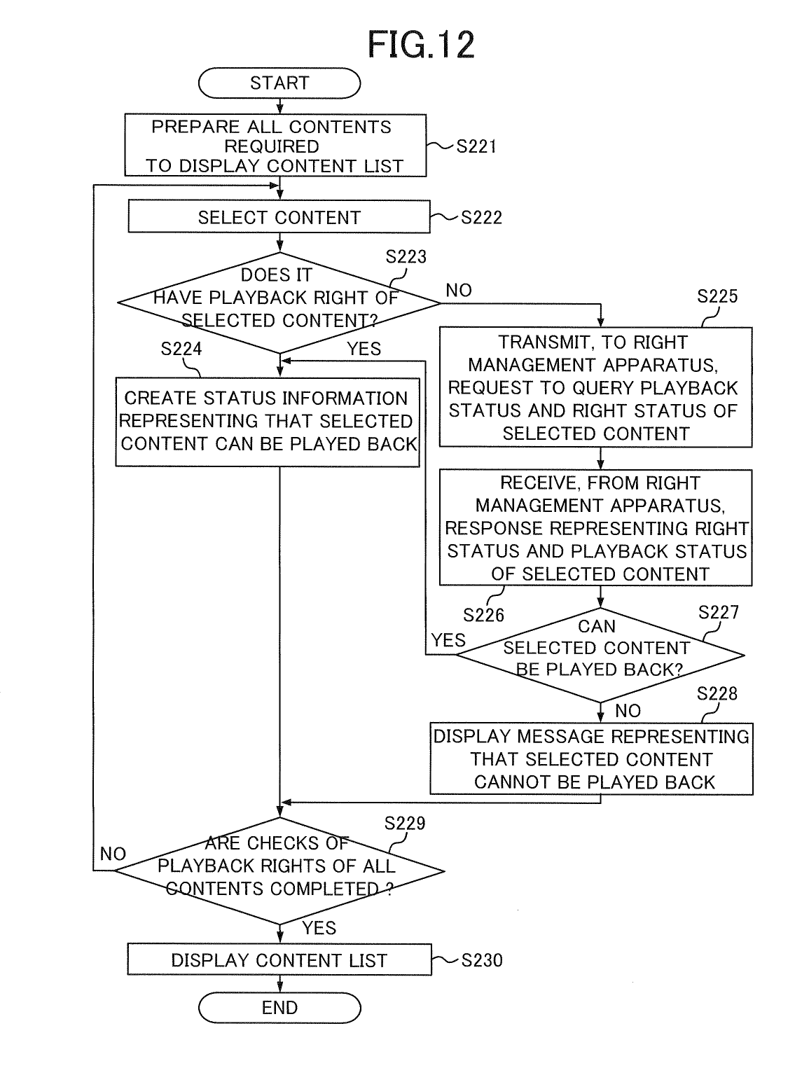

FIGS. 11 and 12 are flowcharts indicative of modified right transfer operations of the content playback system 2 according to this embodiment. Specifically, each of FIGS. 11 and 12 is a flowchart illustrating the flow of right transfer operations of an information playback apparatus 5 in the content playback system 2 when the information playback apparatus 5 plays back a digital content stored in the NAS 6. Note that the operations illustrated in FIGS. 11 and 12 are carried out by the CPU 516 of the corresponding information playback apparatus 5.

Operations of an information playback apparatus 5 in the content playback system 2 when the information playback apparatus 5 plays back a digital content stored in the NAS 6 will be described hereinafter with reference to FIG. 11.

When accepting a display request of the list of contents from a user in step S210, an information playback apparatus 5 performs a content-list display task to display a content list L20 as the list of all digital contents stored in the NAS 6 on the image display device, such as a television, connected with the information playback apparatus 5 in step S220.

The content-list display task will be described in detail hereinafter with reference to FIG. 12. FIG. 12 is a flowchart fully illustrating the flow of the content-list display task in step S220 of FIG. 11.

First, the information playback apparatus 5 prepares all digital contents required to display a content list L20 in step S221. Specifically, the information playback apparatus 5 prepares information relating to all the digital contents stored in the NAS 6.

Next, the information playback apparatus 5 selects one of all of the prepared digital contents in step S222, and determines whether it has the playback right of the selected digital content in step S223.

When having the playback right of the selected digital content (YES in step S223), the information playback apparatus 5 creates the status information representing that the selected content can be played back in step S224. For example, when the information playback apparatus 5A has the playback right of a content A, the information playback apparatus 5A creates the status information representing that the content A can be played back and it has the playback right of the content A.

Otherwise, the information playback apparatus 5 does not have the playback right of the selected digital content (NO in step S223), the information playback apparatus 5 proceeds to step S225. In step S225, the information playback apparatus 5 transmits, to the right management apparatus 7, a request (first request) that queries the playback status and the right status of the selected digital content in order to grasp: which of the information playback apparatuses 5 has the playback right of the selected digital content; and whether an alternative information playback apparatus 5 having the playback right of the selected digital content is playing back the selected digital content in step S225.

Next, when receiving, from the right management apparatus 7, a response (first response) indicative of the right status and playback status of the selected digital content in step S226, the information playback apparatus 5 determines whether the selected digital content can be played back in step S227.

When it is determined that the selected digital content can be played back (YES in step S227), the information playback apparatus 5 creates the status information representing that the selected content can be played back in step S224. For example, when the information playback apparatus 5A receives the first response representing that the information playback apparatus 5B has the playback right of a content A and is not playing back the content A, the information playback apparatus 5A creates the status information representing that the content A can be played back and the information playback apparatus 5B has the playback right of the content A.

Otherwise, when it is determined that the selected digital content cannot be played back (NO in step S227), the information playback apparatus 5 creates the status information representing that the selected digital content cannot be played back in step S228. For example, when the information playback apparatus 5A receives the first response representing that the information playback apparatus 5B has the playback right of a content A and is playing back the content A, the information playback apparatus 5A creates the status information representing that the content A cannot be played back and the information playback apparatus 5B has the playback right of the content A.

Next, the information playback apparatus 5 determines whether checks of the playback rights of all the prepared digital contents are completed in step S229. When it is determined that checks of the playback rights of all the prepared digital contents are completed (YES in step S229), the information playback apparatus 5 displays a content list L2 including, in addition to the title and content attribute information of each digital content, the status information on the image display device, such as a TV, connected with the information playback apparatus 5 in step S230.

Otherwise, when it is determined that checks of the playback rights of all the prepared digital contents are not completed (NO in step S229), the information playback apparatus 5 returns to step S222, selects a next digital content, and performs the operations in steps S223 to S228.

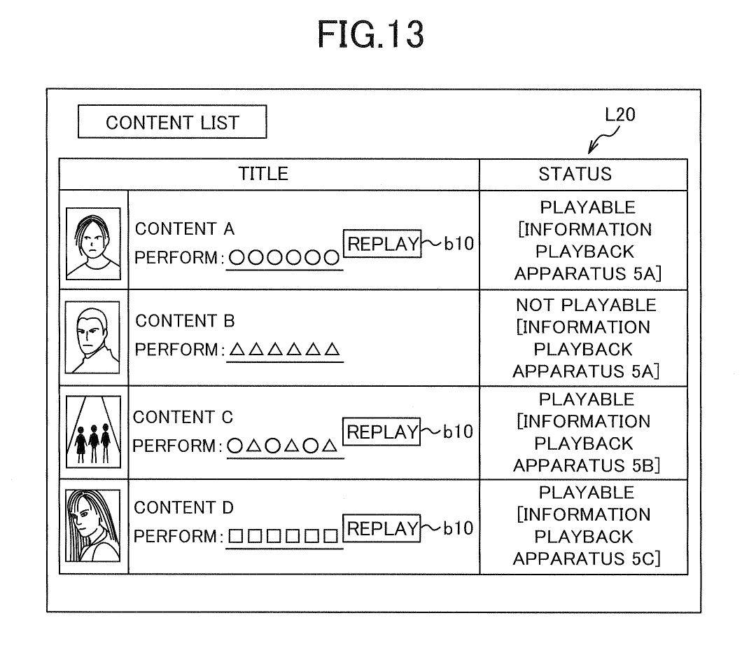

An example of the content list L20 is illustrated in FIG. 13. In the content list L20 illustrated in FIG. 13, for each digital content, the title, the content attribute information (the title name, the jacket image of a corresponding content, and performer information), and the status information are displayed. For example, for a content B, information representing that a corresponding apparatus cannot play back it and the information playback apparatus 5C has the corresponding playback right is displayed. In addition for a content C, information representing that a corresponding apparatus can play back it and the information playback apparatus 5B has the corresponding playback right is displayed. This allows a user to select any of the digital contents in the content list L20. Specifically, selecting one of playback buttons b10 provided for the respective titles allows a corresponding digital content to be selected.

Returning to FIG. 11, when accepting selection of a digital content to be played back from a user in step S240, the information playback apparatus 5 determines whether it has the playback right of the selected digital content in step S250.

When having the playback right of the selected digital content YES in step S250), the information playback apparatus 5 starts to play back the selected digital content in step S260.

Otherwise if the information playback apparatus 5 does not have the playback right of the selected digital content (NO in step S250), the information recording apparatus 5 performs a certification-data transfer task for transferring the certification data relating to the selected digital content from an alternative information playback apparatus 5 having the playback right of the selected digital content to the information playback apparatus 5 in step S80. If the certification data transfer task is successful, the information playback apparatus 5 starts to play back the selected digital content in step S260. Note that, because the certification-data transfer task is identical to that in step S80 illustrated in FIG. 7, the descriptions of it are omitted.

As described above, the modification displays the content L20 including the right status and playback status of a digital content. This allows a user to check whether a desired digital content can be played back by a corresponding apparatus before selecting it. This results in that a user can select a desired content in a plurality of playable digital contents.

In this embodiment and its modification, the right management apparatus 7 is located in the home network 4, but the location of the right management apparatus 7 is not limited thereto. For example, the right management apparatus 7 can be located outside the home network 4, and can be connected with the content playback system 2 via the communication network 3. In this case, the right management apparatus 7 is not provided for each user's house (home network 4), but it can manage a plurality of content playback systems 2 constructed in respective user's houses. Specifically, the right management DB 701 is provided with right management information 710 for each content playback system 2.

In this embodiment and its modification, the copy management system 10 and the content playback system 2 are systems that conform to the standard of “Managed Copy”, but the copy playback system 2 is not limited thereto. Specifically, the content playback system 2 can conform to any standard as long as the playback right of each content is given to only one information playback apparatus, and the playback right of each content can be transferred to another information playback apparatus.

The present invention is not limited to the embodiment set forth above, and the embodiment of the present invention can be deformed or modified within the scope of the present invention. Such deformations or modifications based on the embodiment can be within the technical range of the present invention.

### DESCRIPTION OF CHARACTERS

1 Managed-copy authorization server
2 Content playback system
3 Communication network
4 Home network
5 Managed-copy compliant information recording/playback apparatus
6 NAS
7 Right management apparatus
10 Copy management system
101 Copy-count management DB
102 Control unit
103 Communication unit
110 Copy management information
111 Disc ID
112 Copy-count information
113 Copy limitation information
501 HDD
502 BD/DVD drive
503 Card I/F
504 Ethernet® I/F
505 USE IF
506 Digital tuner
507 Video ADC
508 Audio ADC
509 HDMI IF
510 Video DAC
511 Audio DAC
512 AV pre/post processor
513 AV encoder
514 AV decoder
515 Stream processor
516 CPU
517 Nonvolatile memory
518 Primary storage memory
701 Right management DB
702 Control unit
703 Communication unit
710 Right management information
L10, L20 Content list

1. A right management apparatus of a content playback system comprised of, on a predetermined network, an information storage apparatus storing therein one or more digital contents; the right management apparatus that manages one or more playback rights of the one or more digital contents stored in the information storage apparatus; and a plurality of information playback apparatuses for playing back the one or more digital contents stored in the information storage apparatus, the information storage apparatus, the right management apparatus, and the plurality of information playback apparatuses being connected with each other, each of the one or more playback rights of the one or more digital contents being given to any one of the plurality of information playback apparatuses and being transferrable among the plurality of information playback apparatuses, the right management apparatus comprising:
an information storage means that stores therein right management information that correlates each of the one or more digital contents stored in the information storage apparatus with a corresponding on of the information playback apparatuses to which the playback right of a corresponding one of the digital contents is given;
a first request receiving means that receives, from the information playback apparatus, a first request that queries a right status and a playback status of a selected digital content in the one or more digital contents stored in the information storage apparatus;
a right status obtaining means that references, based on the received first request, the right management information stored in the information storage means to obtain, as the right status of the selected digital content, information representing that the playback right of the selected digital content is given to which of the information playback apparatuses;
a second request transmitting means that transmits, to the information playback apparatus having the playback right of the selected digital content according to the right status obtained by the right status obtaining means, a second request that queries a playback status representing that the selected digital content is playing back;
a second response receiving means that receives, from the information playback apparatus having the playback right of the selected digital content, a second response indicative of the playback status of the selected digital content; and
a first response transmitting means that transmits, to the information playback apparatus that has transmitted the first request, a first response created based on the right status obtained by the right status obtaining means and the playback status received by the second response receiving means, the first response representing the right status and playback status of the selected digital content.

2. The right management apparatus according to claim 1, wherein, when the information playback apparatus that has transmitted the first request performs a right transfer task to transfer the playback right of the selected digital content thereto, the right management apparatus further comprising:
a message receiving means that receives, from the information playback apparatus that has transmitted the first request, a right transfer message representing that the playback right of the selected digital content belongs to the corresponding apparatus; and
an information updating means that updates the right management information stored in the information storage means based on the received right transfer message.

3. A right management computer program product embedded in a computer-readable media and readable by a right management apparatus of a content playback system comprised of, on a predetermined network, an information storage apparatus storing therein one or more digital contents; the right management apparatus that manages one or more playback rights of the one or more digital contents stored in the information storage apparatus; and a plurality of information playback apparatuses for playing back the one or more digital contents stored in the information storage apparatus, the information storage apparatus, the right management apparatus, and the plurality of information playback apparatuses being connected with each other, each of the one or more playback rights of the one or more digital contents being given to any one of the plurality of information playback apparatuses and being transferrable among the plurality of information playback apparatuses, the computer program product functioning the right management apparatus as:
an information storage means that stores therein right management information that correlates each of the one or more digital contents stored in the information storage apparatus with a corresponding one of the information playback apparatuses to which the playback right of a corresponding one of the digital contents is given;
a first request receiving means that receives, from the information playback apparatus, a first request that queries a right status and a playback status of a selected digital content in the one or more digital contents stored in the information storage apparatus;
a right status obtaining means that references, based on the received first request, the right management information stored in the information storage means to obtain, as the right status of the selected digital content, information representing that the playback right of the selected digital content is given to which of the information playback apparatuses;
a second request transmitting means that transmits, to the information playback apparatus having the playback right of the selected digital content according to the right status obtained by the right status obtaining means, a second request that queries a playback status representing that the selected digital content is playing back;
a second response receiving means that receives, from the information playback apparatus having the playback right of the selected digital content, a second response indicative of the playback status of the selected digital content; and
a first response transmitting means that transmits, to the information playback apparatus that has transmitted the first request, a first response created based on the right status obtained by the right status obtaining means and the playback status received by the second response receiving means, the first response representing the right status and playback status of the selected digital content.

4. The right management computer program product according to claim 3, wherein the computer program product further functions the right management apparatus as:
when the information playback apparatus that has transmitted the first request performs a right transfer task to transfer the playback right of the selected digital content thereto, a message receiving means that receives, from the information playback apparatus that has transmitted the first request, a right transfer message representing that the playback right of the selected digital content belongs to the corresponding apparatus; and
an information updating means that updates the right management information stored in the information storage means based on the received right transfer message.

5. A content playback system comprised of, on a predetermined network, an information storage apparatus storing therein one or more digital contents; a right management apparatus that manages one or more playback rights of the one or more digital contents stored in the information storage apparatus; and a plurality of information playback apparatuses for playing back the one or more digital contents stored in the information storage apparatus, the information storage apparatus, the right management apparatus, and the plurality of information playback apparatuses being connected with each other, each of the one or more playback rights of the one or more digital contents being given to any one of the plurality of information playback apparatuses and being transferrable among the plurality of information playback apparatuses, the right management apparatus comprising:
an information storage means that stores therein right management information that correlates each of the one or more digital contents stored in the information storage apparatus with a corresponding one of the information playback apparatuses to which the playback right of a corresponding one of the digital contents is given;
a first request receiving means that receives, from the information playback apparatus, a first request that queries a right status and a playback status of a selected digital content in the one or more digital contents stored in the information storage apparatus;
a right status obtaining means that references, based on the received first request, the right management information stored in the information storage means to obtain, as the right status of the selected digital content, information representing that the playback right is given to which of the information playback apparatuses;
a second request transmitting means that transmits, to the information playback apparatus having the playback right of the selected digital content according to the right status obtained by the right status obtaining means, a second request that queries a playback status representing that the selected digital content is playing back;
a second response receiving means that receives, from the information playback apparatus having the playback right of the selected digital content, a second response indicative of the playback status of the selected digital content; and
a first response transmitting means that transmits, to the information playback apparatus that has transmitted the first request, a first response created based on the right status obtained by the right status obtaining means and the playback status received by the second response receiving means, the first response representing the right status and playback status of the selected digital content,
at least one of the information playback apparatuses comprising:
a first request transmitting means that transmits, to the right management apparatus, the first request;
a first response receiving means that receives the first response from the right management apparatus;
a right transfer means that performs a right transfer task when it is determined, based on the playback status of the received first response, that the selected digital content is not playing back, the right transfer task transferring the playback right of the selected digital content from an alternative information playback apparatus that has the playback right of the selected digital content to the corresponding apparatus, based on the right status of the received first response; and
a content playback means that stores therein the playback right of the selected digital content, thus playing back the selected digital content.

6. The content playback system according to claim 5, wherein the at least one of the information playback apparatuses further comprises a message transmitting means that transmits, when the transfer of the playback right of the selected digital content is performed by the right transfer means, a right transfer message representing that the playback right of the selected digital content belongs to the corresponding apparatus, and the right management apparatus further comprises:
a message receiving means that receives, from the at least one of the information playback apparatuses, the right transfer message; and
an information updating means that updates the right management information stored in the information storage means based on the received right transfer message.

7. The content playback system according to claim 5, wherein, when determining, based on the received playback status of the first response, that the selected digital content is playing back, the at least one of the information playback apparatuses displays, on a screen of a predetermined display device, a message representing that the selected digital content is not allowed to be played back.

8. The content playback system according to claim 5, wherein the at least one of the information playback apparatuses further comprises:
a list displaying means that displays a list of the one or more digital contents stored in the information storage means;
a content selecting means that selects one digital content in the list displayed by the list displaying means; and
a first request creating means that creates the first request based on the digital content selected by the content selecting means.

9. The content playback system according to claim 5, wherein the first request transmitting means transmits the first request for each of the one or more digital contents stored in the information storage means,
the first request receiving means receives the first response for each of the one or more digital contents stored in the information storage means, and
the at least one of the information playback apparatuses further comprises:
a list displaying means that displays a list of the one or more digital contents stored in the information storage means in addition to the received first response for each of the one or more digital contents stored in the information storage means; and
a content selecting means that selects one playable digital content in the list displayed by the list displaying means,
the right transfer means performing, based on the right status of the digital content selected by the content selecting means, the right transfer task that transfers the playback right of the selected digital content from the information playback apparatus that has the playback right of the selected digital content to the corresponding apparatus.

10. The content playback system according to claim 5, wherein each of the information playback apparatuses is an apparatus compliant with a standard of AACS managed copy, and, when the at least one of the information playback apparatuses copies a given original digital content to the information storage apparatus, a playback right of a copied digital content is given to the corresponding apparatus.
